(19) United States
(12) Patent Application Publication
(10) Pub. No.: US 2016/0186693 A1
(43) Pub. Date: Jun. 30, 2016

(54) Exhaust Gas Recirculation Mixer

(71) Applicant: Electro-Motive Diesel, Inc., LaGrange, IL (US)

(72) Inventors: Steve Johnson, LaGrange, IL (US); Gary Svihla, Burr Ridge, IL (US); Josh Schueler, LaGrange, IL (US); Pradeep Ganesan, LaGrange, IL (US)

(73) Assignee: ELECTRO-MOTIVE DIESEL, INC., LaGrange, IL (US)

(21) Appl. No.: 14/584,400

(22) Filed: Dec. 29, 2014

(51) Int. Cl. F02M 25/07

(52) U.S. Cl. CPC F02M 25/0722; F02M 25/0726; F02M 25/0714

(57) ABSTRACT

An exhaust gas recirculation system may include a header located at an end of a cooler, and a mixer for mixing exhaust gases and intake air within the header. The mixer may include a passage for receiving exhaust gases and an inlet for receiving intake air. The exhaust gases and intake air may collide at a substantially perpendicular angle within the mixer, and the mixer may further include an outlet for emitting mixed exhaust gases and intake air.

### TECHNICAL FIELD

The present disclosure generally relates to internal combustion engines, and more particularly, relates to an exhaust gas recirculation mixer for use with an internal combustion engine.

### BACKGROUND

Internal combustion engines are commonly used in a variety of applications, including vehicles, power generation or industrial settings, to convert chemical fuel energy into mechanical and heat energy. Such vehicles may include railroad locomotives, earth-moving machines and the like. An internal combustion engine can incorporate turbocharging or supercharging to compress incoming air for a more efficient operation. Further, coolers can remove excess heat from the compressed air to aid combustion properties. Diesel fuel, gasoline or other fuels can be burned during operation.

An internal combustion engine may employ an exhaust gas recirculation system. Such a system recirculates a fraction of combustion exhaust gases from the internal combustion engine back into the intake air. This process may reduce total exhaust emissions (particularly nitrous oxides), and may further increase engine combustion efficiency. An exhaust gas recirculation system may require the mixing of exhaust gas and incoming air. This mixture is then fed into the cylinders of the engine for combustion with a fuel. A more complete mixing of the exhaust gases and intake air may produce a more effective exhaust gas recirculation system.

Cook (U.S. Pat. No. 7,793,498) discloses an “Integrated Charge Air Cooler and Exhaust Gas Recirculation Mixer.” Cook describes a charge air cooler integrating an exhaust gas recirculation mixer. However, mixing recirculation gases within a charge air cooler requires an extended length, or disadvantageous packaging, of exhaust gas recirculation ductwork. This necessarily increases cost and space requirements.

Accordingly, there is a need for an improved exhaust gas recirculation mixer.

### SUMMARY OF THE DISCLOSURE

In one aspect, an exhaust gas recirculation system is disclosed. The exhaust gas recirculation system may include a cooler, a header located at an end of the cooler, and a mixer for mixing exhaust gases and intake air, the mixer may be located within the header.

In another aspect, an internal combustion engine is disclosed. The internal combustion engine may include an engine block, one or more cylinders provided in the engine block, a cooler operatively associated with the one or more cylinders, a header located at an end of the cooler, and a mixer located within the header, the mixer adapted to mix exhaust gases and intake air prior to introduction into the one or more cylinders.

In another aspect, a method of mixing exhaust gases and intake air in an internal combustion engine is disclosed. The method may include positioning a header at an end of a cooler of the internal combustion engine, mixing exhaust gases and intake air in a mixer located within the header, the mixer including a passage for receiving exhaust gases, an inlet for receiving intake air and an outlet for emitting mixed exhaust gases and intake air.

These, and other aspects and features of the present disclosure, will be better understood upon reading the following detailed description when taken in conjunction with the accompanying drawings.

### BRIEF DESCRIPTION OF THE DRAWINGS

For further understanding of the disclosed concepts and embodiments, reference may be made to the following detailed description, read in connection with the drawings, wherein like elements are numbered alike, and in which:

FIG. 1 is a schematic side view of a locomotive and a train including a number of cars constructed in accordance with the present disclosure.

FIG. 2 is a perspective view of an internal combustion engine in accordance with the present disclosure.

FIG. 3 is a cross-sectional view of a mixer and exhaust gas recirculation system constructed in accordance with the present disclosure.

FIG. 4 is another cross-sectional view of the exhaust gas recirculation system of FIG. 3 but taken from a top perspective.

FIG. 5 is a perspective view of the mixer and exhaust gas recirculation system of FIG. 3.

FIG. 6 is another cross-sectional view of the mixer and exhaust gas recirculation system of FIG. 3, but showing gas flow directions.

FIG. 7 is a flowchart depicting a sample sequence of actions which may be practiced in an embodiment of the present disclosure.

It is to be noted that the appended drawings illustrate only typical embodiments and are therefore not to be considered limiting with respect to the scope of the disclosure or claims. Rather, the concepts of the present disclosure may apply within other equally effective embodiments. Moreover, the drawings are not necessarily to scale, emphasis generally being placed upon illustrating the principles of certain embodiments.

### DETAILED DESCRIPTION

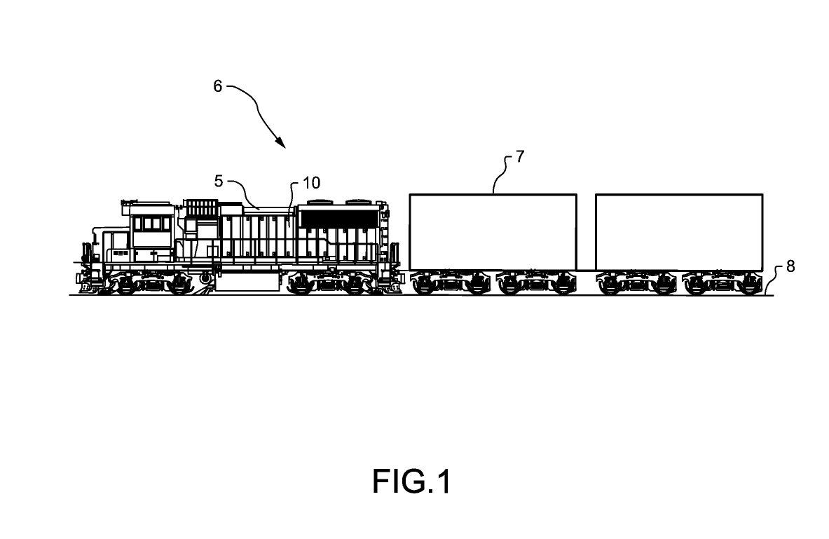

Referring now to the drawings, and with specific reference to FIG. 1, a locomotive constructed in accordance with the present disclosure is generally referred to by reference numeral 5. The locomotive 5 may pull a train 6 consisting of a variety of cars 7 along one or more rails 8, as shown in FIG. 1. Rail transportation is commonly used to move people and cargo. The locomotive 5 may further include an internal combustion engine 10 constructed in accordance with the present disclosure and generally referred to by reference numeral 10.

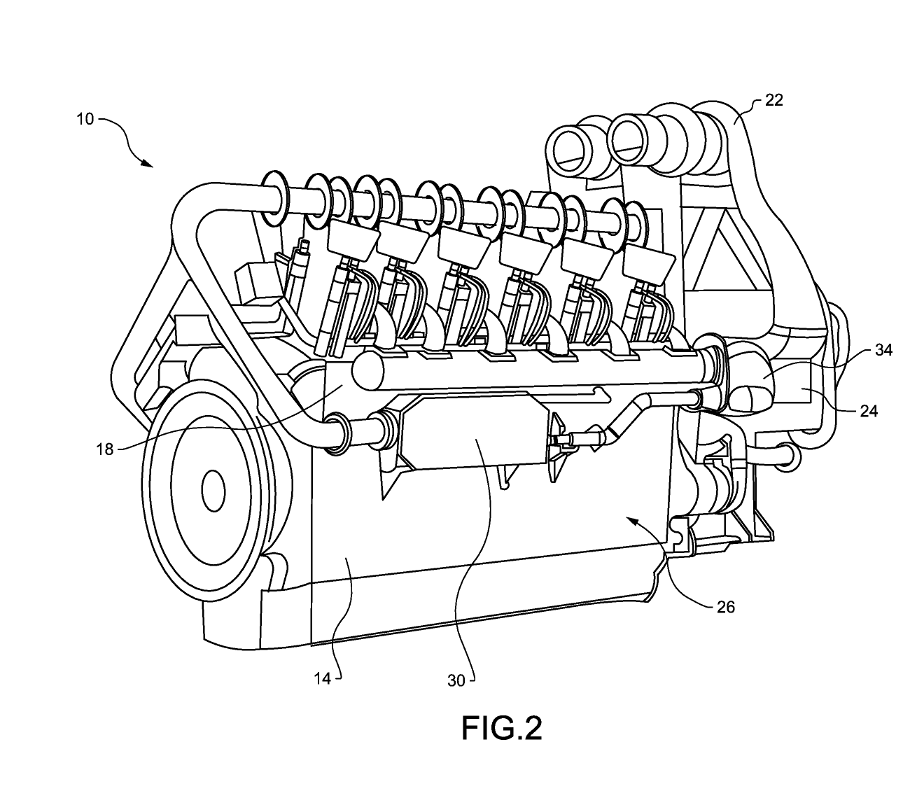

Turning to FIG. 2, the internal combustion engine 10 may include an engine block 14 having one or more cylinders 18. The internal combustion engine 10 may function by drawing intake air into the cylinders 18, mixing the air with a fuel, compressing the mixed air and fuel, igniting the mixture, and expelling exhaust gases. In the process, the reciprocating motion of certain internal combustion engine 10 components can be converted into rotational motion for useful work. This useful work can, for example, be used to power the locomotive 5, an earth-moving vehicle, other vehicle or industrial process. The internal combustion engine 10 may be a spark-ignition engine or a compression-ignition engine, and may be designed to use gasoline, diesel fuel, natural gas or other fuels.

One or more forced induction systems, including a turbocharger 22, can compress the intake air for increased combustion efficiency. As the compression process may raise the temperature of the intake air, one or more coolers 24 may be used to lower the temperature of the compressed air prior to introduction into the cylinders 18. The cooler 24 may be an aftercooler, located downstream of a forced induction system, or an intercooler, located between components of a forced induction system. The cooled air is denser than warmer air, thus allowing a greater mass of air to enter the cylinders 18 for improved combustion.

The internal combustion engine 10 may also employ an exhaust gas recirculation system 26. Such a system recirculates a fraction of combustion exhaust gases from the internal combustion engine 10 back into the intake air. Among other things, this process may reduce total exhaust emissions (particularly nitrous oxides), and may further increase internal combustion engine 10 operating efficiency. To increase effectiveness, the exhaust gas recirculation system 26 mixes the exhaust gas and incoming air. This mixture is then fed into the cylinders 18 of the internal combustion engine 10 for combustion. A more complete mixing of the exhaust gases and incoming air may produce a more effective exhaust gas recirculation system 26 and internal combustion engine 10 operation. As with the intake air mentioned above, the exhaust gases may be cooled by an exhaust gas cooler 30 prior to the mixing of the exhaust gases with intake air. Additionally, the exhaust gas recirculation 26 system may be provided with the internal combustion engine 10 without increasing space requirements for the internal combustion engine 10.

For improved combustion, the exhaust gas recirculation system 26 mixes the intake air and exhaust gases prior to use in the internal combustion engine 10. One technique for more thoroughly mixing the exhaust gases and intake air includes allowing more time for the mixing to occur. If the gases are flowing through a system, increased mixing time may result from a greater distance between the initial mixing point of the gases and the end point of the mixture flow. To this end, a mixer 34 may be used to mix intake air and exhaust gases.

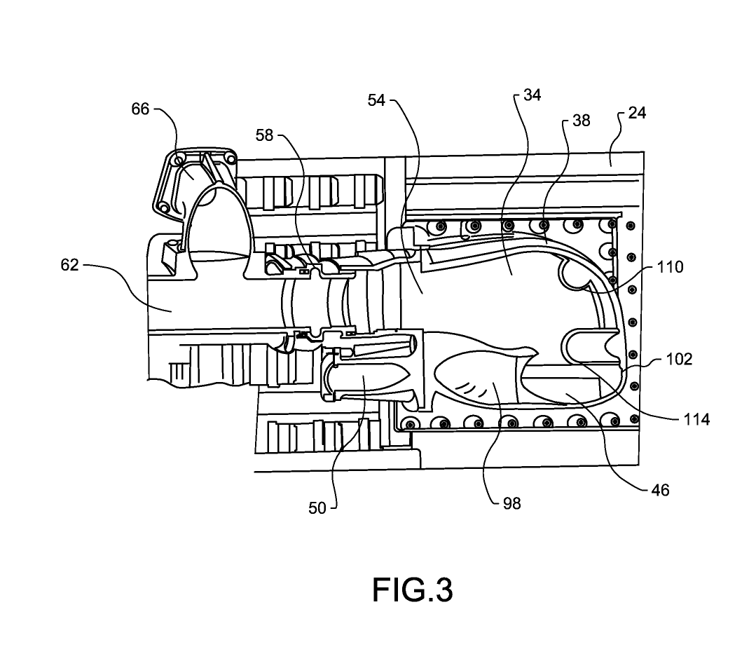

The mixer 34 may be located in any number of locations such as, but not limited to, within a header 38, as shown in FIG. 3. The header 38 may be located adjacent to the cooler 24, may define a surface of the cooler 24 and may house various components of the cooler. The header 38 may be positioned at an end of the cooler 24. Additionally, the mixer 34 may be located so as to allow greater time and space for the exhaust gases and intake air to thoroughly mix.

In order to communicate gases to the mixer, the intake air is communicated into the mixer 34 by way of an inlet 46 and exhaust gases are communicated into the mixer by way of a passage 50. Following the mixing of exhaust gases and intake air within the mixer 34, the mixed gases may travel through an outlet 54 and a transition element 58, and into an intake manifold 62. The mixture may then pass through an intake elbow 66 for eventual combustion within the cylinders 18.

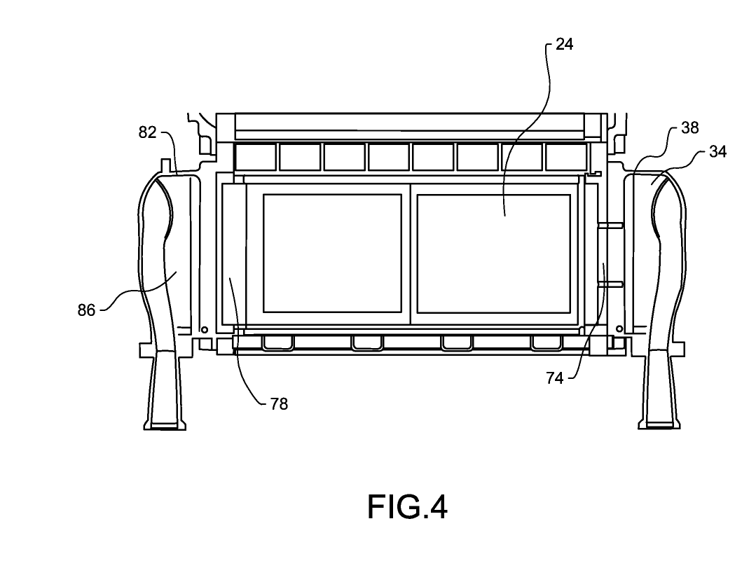

In an embodiment, the cooler 24 may have multiple ends, and first and second headers 38, 82 may be located at more than one end, as shown in FIG. 4. First and second mixers 34, 86 may be located in each header 38, 82. In particular, the cooler 24 may include a first end 74 and a second end 78. The header 38 may be located on the first end 74. In addition, a second header 82 may be located at the second end 78, and a second mixer 86 may be located in the second header 82. The first end 74 and the second end 78 may be on opposite sides of the cooler 24.

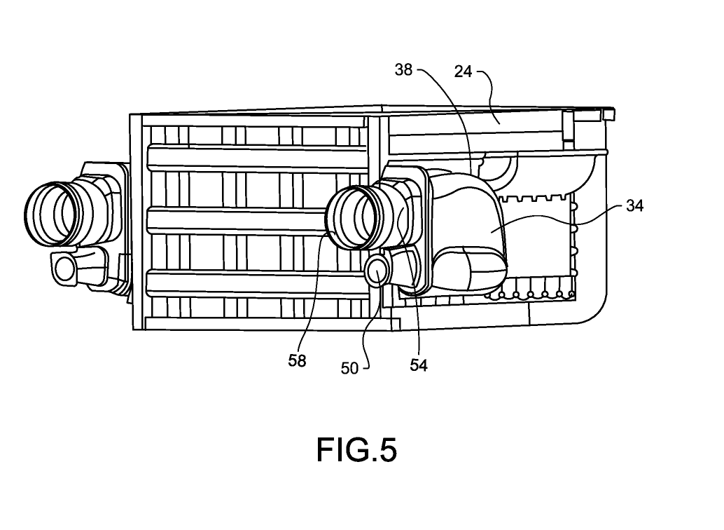

Various elements of the present disclosure can also be seen from another perspective in FIG. 5, including the cooler 24, the mixer 34, the header 38, the passage 50, the outlet 54 and the transition element 58.

In operation, exhaust gases may result from internal combustion engine 10 combustion and travel into the mixer 34 via the passage 50. Simultaneously, intake air may enter the mixer 34 via the inlet 46. These two gases may then mix within the mixer 34 before and after the mixture exits the mixer 34 through the outlet 54.

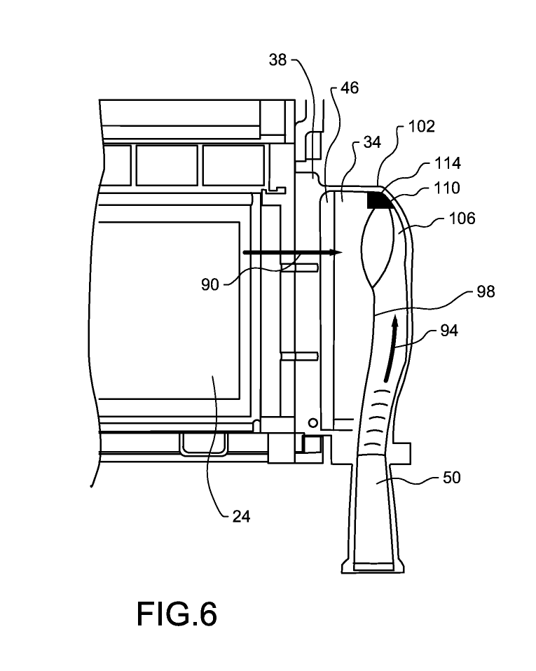

Details of the mixer 34 are shown in FIGS. 3 and 6. An intake air flow 90 may enter the mixer 34 through the inlet 46. Simultaneously, an exhaust gas recirculation flow 94 may enter the mixer 34 through the passage 50. A partition 98 may exist between the flows 90, 94, and the partition 98 may form a section of the passage 50. The partition 98 may separate or guide the flows 90, 94, and may be disposed within the mixer 34 to enhance turbulent mixing. As the two gas flows 90, 94 enter the mixer 34 and interact, they may be relatively oriented in a manner that increases the level of mixing. Further, the two gas flows 90, 94 may collide at a substantially perpendicular, or otherwise transverse, angle within the mixer 34. The mixer 34 may also be shaped to improve the mixing of the exhaust gases and the intake air. This mixer 34 shape may be determined by using computational fluid dynamics simulations, or through other methods. The greater mixing capacity may be accomplished by inducing turbulence or other flow 90, 94 interactions within the mixer.

The mixer shape mentioned above may be partially defined by a wall 102. The wall 102 may interact with the exhaust gas recirculation flow 94. The wall 102 may be positioned inside the mixer 34 and may form a surface of the mixer 34. Further, the wall 102 may be oriented substantially normally to the exhaust gas recirculation flow 94, or at another orientation relative to the exhaust gas recirculation flow 94 to increase gas mixing. The wall 102 may also be shaped or oriented in such a manner so as to decrease noise or flow restrictions. The exhaust gas recirculation flow 94 may also impinge upon the wall 102.

Similarly, a surface 106 may partially define the aforementioned shape and interact with the intake air flow 90. The surface 106 may be positioned inside the mixer 34 and may form a surface of the mixer 34. Further, the surface 106 may be oriented substantially normally to the intake air flow 90, or at another orientation relative to the intake air flow 90 to increase gas mixing. The surface 106 may also be shaped or oriented in such a manner so as to decrease noise or flow restrictions.

In a still further embodiment, a swirler 110 may be disposed within the mixer 34 to increase gas mixing between the intake air and the exhaust gases. The swirler 110 may be a protrusion 114, or another shape, designed to swirl the gases for increased mixing.

The header 38 may be manufactured from any number of different processes or structures such as, but not limited to, a casting, a machining or a weldment. With respect to materials, the header 38 may be made of any number of different materials, including metal, a metal alloy, cast iron, steel or ceramic. Additionally, the disclosed exhaust gas recirculation system 26 and mixer 34 may be used with a spark-ignition or otto cycle internal combustion engine 10 or a compression-ignition or diesel cycle internal combustion engine 10.

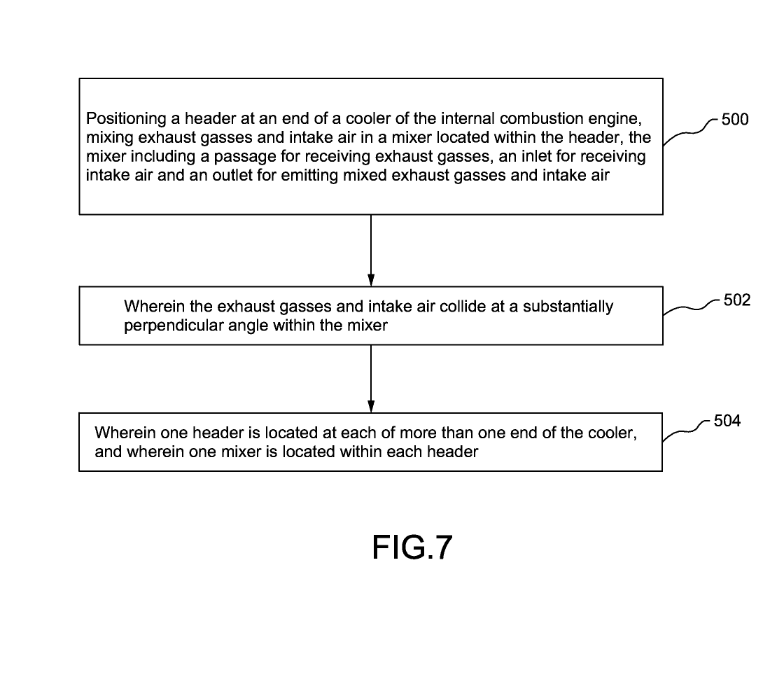

A method of mixing exhaust gases and intake air in operation can be understood by referencing the flowchart in FIG. 7. The method may comprise positioning the header 38 at an end of the cooler 24 of the internal combustion engine 10, mixing exhaust gases and intake air in the mixer 34 located within the header 38, the mixer 34 including a passage 50 for receiving exhaust gases, an inlet 46 for receiving intake air and an outlet 54 for emitting mixed exhaust gases and intake air, as described in step 500. The exhaust gases and intake air may collide at a substantially perpendicular, or otherwise transverse, angle within the mixer 34, as described in step 502. Further, one header 38, 82 may be located at each of more than one end of the cooler 24, and one mixer 34, 86 may be located within each header 38, 82.

### INDUSTRIAL APPLICABILITY

In operation, the present disclosure sets forth an exhaust gas recirculation system which can find industrial applicability in a variety of settings. For example, the disclosure may be advantageously employed in the efficient operation of internal combustion engines.

Such engines may be provided on many different machines such as, but not limited to, locomotives and earth-moving machines. More specifically, the exhaust gas recirculation system may recirculate a fraction of combustion exhaust gases from the internal combustion engine into the intake air. This process may reduce total exhaust emissions (particularly nitrous oxides), and may increase engine combustion efficiency. Further, the disclosed exhaust gas recirculation system employs locations and mixer shapes which thoroughly mix exhaust gases and intake air, while doing so within existing dimensional measurements of the internal combustion engine.

For example, the present disclosure in one embodiment places the mixer in the aftercooler header of the engine. In doing so, the actual mixing of the exhaust gases and intake air is performed at a significant distance from the cylinder intakes, thus facilitating improved mixing. Moreover, the specific shape of the mixer may facilitate more complete and thorough mixing for improved combustion and output.

The disclosed exhaust gas recirculation system may be original equipment on new internal combustion engines, or added as a retrofit to existing internal combustion engines.

What is claimed is:

1. An exhaust gas recirculation system, comprising:
a cooler;
a header, the header located at an end of the cooler; and
a mixer for mixing exhaust gases and intake air, the mixer located within the header.

2. The exhaust gas recirculation system of claim 1, wherein the mixer includes a passage for receiving exhaust gases and an inlet for receiving intake air.

3. The exhaust gas recirculation system of claim 2, wherein the exhaust gases and intake air collide at a substantially perpendicular angle within the mixer.

4. The exhaust gas recirculation system of claim 1, wherein the mixer includes an outlet for emitting mixed exhaust gases and intake air.

5. The exhaust gas recirculation system of claim 1, wherein one header is located at each of more than one end of the cooler, and wherein one mixer is located within each header.

6. The exhaust gas recirculation system of claim 1, wherein the header is a casting.

7. The exhaust gas recirculation system of claim 1, wherein the header is manufactured from a metal.

8. The exhaust gas recirculation system of claim 7, wherein the header is manufactured from cast iron.

9. An internal combustion engine, comprising:
an engine block;
one or more cylinders provided in the engine block;
a cooler operatively associated with the one or more cylinders;
a header located at an end of the cooler; and
a mixer located within the header, the mixer adapted to mix exhaust gases and intake air prior to introduction into the one or more cylinders.

10. The internal combustion engine of claim 9, wherein the mixer includes a passage for receiving exhaust gases and an inlet for receiving intake air.

11. The internal combustion engine of claim 10, wherein the exhaust gases and intake air collide at a substantially perpendicular angle within the mixer.

12. The internal combustion engine of claim 9, wherein the mixer includes an outlet for emitting mixed exhaust gases and intake air.

13. The internal combustion engine of claim 9, wherein one header is located at each of more than one end of the cooler, and wherein one mixer is located within each header.

14. The internal combustion engine of claim 9, wherein the mixer includes a swirler.

15. The internal combustion engine of claim 9, wherein an exhaust gas recirculation system is provided with the internal combustion engine without increasing space requirements for the internal combustion engine.

16. The internal combustion engine of claim 9, wherein the internal combustion engine is a compression-ignition engine.

17. The internal combustion engine of claim 9, wherein the internal combustion engine is a spark-ignition engine.

18. A method of mixing exhaust gases and intake air in an internal combustion engine, comprising:
positioning a header at an end of a cooler of the internal combustion engine, and
mixing exhaust gases and intake air in a mixer located within the header, the mixer including a passage for receiving exhaust gases, an inlet for receiving intake air and an outlet for emitting mixed exhaust gases and intake air.

19. The method of claim 18, wherein the exhaust gases and intake air collide at a substantially perpendicular angle within the mixer.

20. The method of claim 18, wherein one header is located at each of more than one end of the cooler, and wherein one mixer is located within each header.
